(19) United States
(12) Patent Application Publication
(10) Pub. No.: US 2005/0230954 A1
(43) Pub. Date: Oct. 20, 2005

(54) Mailable photograph album

(76) Inventors: Marsha Gray Carrington, Los Angeles, CA (US); James D. Fleming, San Francisco, CA (US)

Correspondence Address: Sean M. Fitzgerald, 3182 Campus Drive #342, San Mateo, CA, 94402-3123, US

(21) Appl. No.: 10/827,658

(22) Filed: Apr. 18, 2004

(51) Int. Cl. B42D 1/00

(52) U.S. Cl. 281/15.1

(57) ABSTRACT

A mailable photo album is constructed from a single cover folded to enclose a plurality of sleeves. The cover formed from a lightweight semi-stiff material is folded to have a top flap attached to a back flap by a side attachment flap. The top cover is held in the closed position by a closing flap, the closing flap attached to the back flap by a second side attachment flap. The sleeves of the mailable photo album are constructed form sandwiches of clear flexible material to create pockets for storage and viewing of photographs stored within the sleeve pockets. The sleeves are attached to the cover by securing one end of the sleeve to a securing flap.

### BACKGROUND

1. Field of the Invention

The field of the invention relates generally to photo albums. More particularly, the present invention relates to the field of providing a photo album that can be sent through a postal service.

2. Related Background

The use of photo albums is common and widespread. Conventional photo albums are constructed to allow photographs to be stored in a way to both preserve and display the photographs stored within the album. As shown FIG. 1A and 1B, a conventional photo album 1 has a cover 2 and a plurality of sleeves 3. The cover is typically made of a stiff material, such as a cardboard or pressboard, and is covered by a material such as a vinyl or plastic. By using a stiff material the cover proves a degree of protection for the photographs in the album, and also provides structural support to allow the album to support the weight of, potentially, many photographs while being transported or handled. The sleeve pages 3 are designed to secure and protect the photographs. A common form of sleeve is the pocket type sleeve where the photographs are placed into a pocket with one clear side, allowing the photograph to be viewed while inside the sleeve. Sleeve pages may include one or more pockets, each pocket holding one or more photographs. Typically, sleeves are formed from a flexible clear material.

The sleeves are secured to the cover by a securing mechanism. One typical securing mechanism is a multiple ring binder, which has a series of securing rings 4 which pass through securing holes in the sleeves, thereby securing the sleeve to the securing mechanism. The securing rings attach to spine clamp 5 which provides structural rigidity to the photo album. The securing rings and spine clamp are typically formed from a metal, for strength and structural rigidity. The securing mechanism is securely fastened to the cover 2.

While conventional photo albums work well to preserve and display photographs, they are typically too bulky to send through the mail. Even smaller sized conventional photo albums are too heavy to fit within an envelope and be mailed at modest cost. Mailing a conventional photo album typically requires additional packing, as the stiff cover and weight of the album are not well suited to being mailed in a conventional envelope.

Additionally, the construction of a conventional photo album, designed to protect photographs over many years, is more costly to make and distribute. The cost of the photo album being driven, in part by the requirements of being sufficiently robust in construction to protect the photographs despite numerous handling of the album. Thus, such albums are prohibitively expensive for mailing photographs to friends or relatives.

Accordingly, a need exists to provide a low-cost mailable photo album.

### BRIEF DESCRIPTION OF THE FIGURES

FIG. 1A is a perspective view of a conventional photo album of the prior art in the closed position.

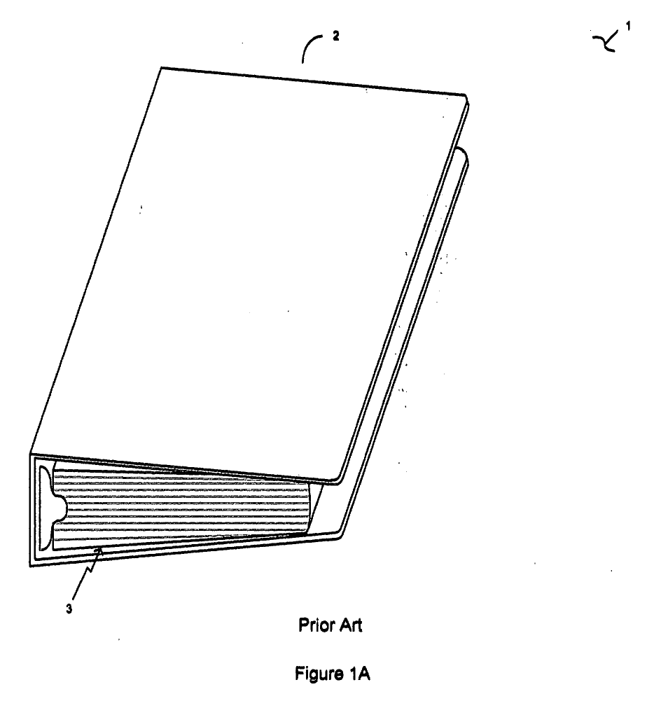

FIG. 1B is a perspective view of a conventional photo album of the prior art in the open position.

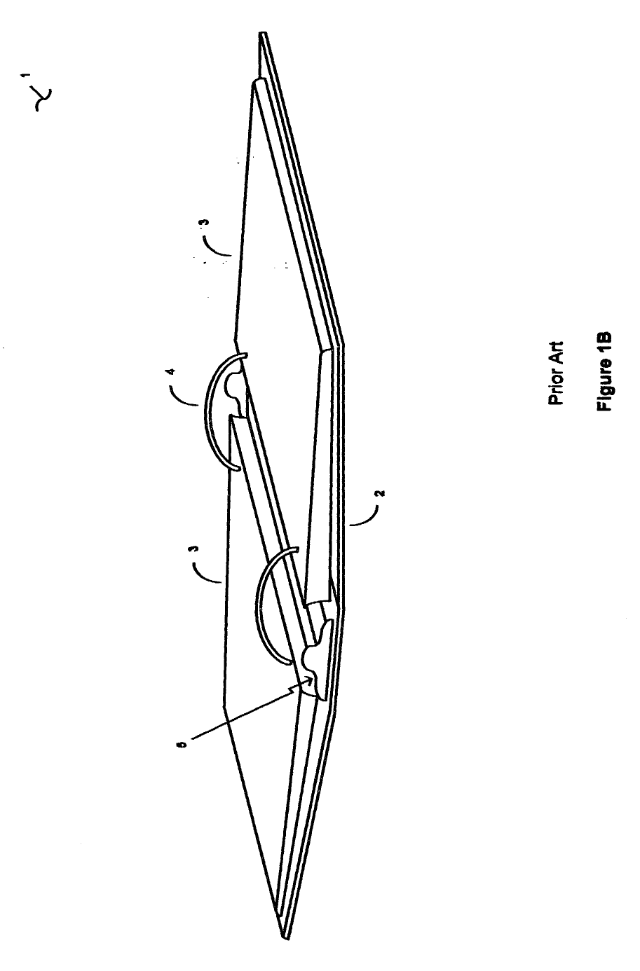

FIG. 2 is a perspective view of a mailable photo album in the closed position, in accordance with the present invention.

FIG. 3 is a perspective view of a mailable photo album in the open position, in accordance with the present invention.

FIG. 4 is a perspective view of the attachment of the photo sleeves to the mailable photo album, in accordance with the present invention.

FIG. 5A is a cross-sectional end view of the mailable photo album illustrating the attachment of the sleeves to the cover, in accordance with the present invention.

FIG. 5B is an expanded cross sectional view of the attachment of the sleeves to the cover illustrated in FIG. 5A, in accordance with the present invention.

FIG. 6 is a perspective view illustrating details of a photo album sleeve, in accordance with the present invention.

FIG. 7 is an exploded perspective view of the component sheets of the sleeve, in accordance with the present invention.

FIG. 8 is a perspective view of a mailer kit including a mailable photo album and a mailing envelope enclosed within a mailer kit display package, in accordance with the present invention.

FIG. 9 is a perspective view of a photo-album envelope included with the mailable photo album, in accordance with the present invention.

FIG. 10 is a perspective view of an alternate embodiment of the present invention having multiple photo pockets per sleeve, in accordance with the present invention.

FIG. 11 depicts and alternate embodiment of the present invention where a mailable photo album includes theme identifiers, in accordance with the present invention.

FIG. 12 is a perspective view of the alternate embodiment of the mailable photo album shown in FIG. 11 illustrating a theme message and customizable note lines, in accordance with the present invention.

FIG. 13 is a perspective view of a mailable photo album with an alternate cover and closing system, in accordance with the present invention.

FIG. 14 is a perspective view of the mailable photo album show in FIG. 13 in the open position, in accordance with the present invention.

FIG. 15 is a perspective view of the mailable photo album show in FIG. 13 and 14 illustrating the hook and loop closing system, in accordance with the present invention.

### SUMMARY

The present invention provides a mailable photo album including a cover formed from a lightweight semi-stiff material; a securing mechanism for keeping the cover in a closed position; and a plurality of sleeves securely attached to the cover, where in the sleeve is formed to hold at least one photograph. The cover including a back flap, a top flap attached to the back flap in a rotatable manner, and a closing flap attached to the back flap, wherein the closing flap formed to secure the top flap by bending the top flap to have one edge of the top flap positioned inside the closing flap. The sleeves include at least one pocket designed to securely hold a photograph such that the photograph is viewable when securely held within the sleeve pocket. The mailable photo album may have sleeves with multiple photo pockets for holding multiple photographs. The mailable photo album may also include a theme graphic on the album cover. Additionally, the theme identifier may also be included on the cover, as well as a theme message on the inside of the photo album.

The mailable photo album may be included in a mailing kit including a mailing envelope sized to fit the mailable photo album, including the proper postage for mailing the album when full with photographs, the mailing kit within a mailer kit display package.

### DETAILED DESCRIPTION

The present invention is described in the context of a specific embodiment. This is done to facilitate the understanding of the features and principles of the present invention and the present invention is not limited to this embodiment. In particular, the present invention is described in the context of a mailable photograph album.

In the following figures like objects are provided with the same identifying number as an aid in understanding the present invention.

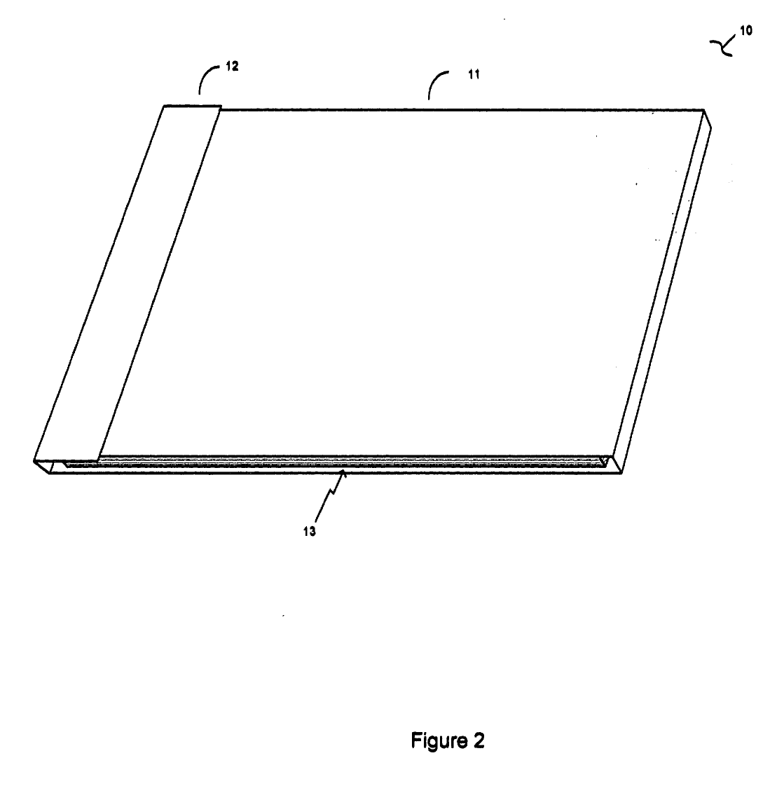

FIG. 2 shows a perspective view of a photo album 10 in the closed position. The photo album 10 has a top flap 11 and a closing flap 12. The top flap 11 is held in place by the closing flap 12, the closing flap 12 resting on top of one edge of the top flap 11.

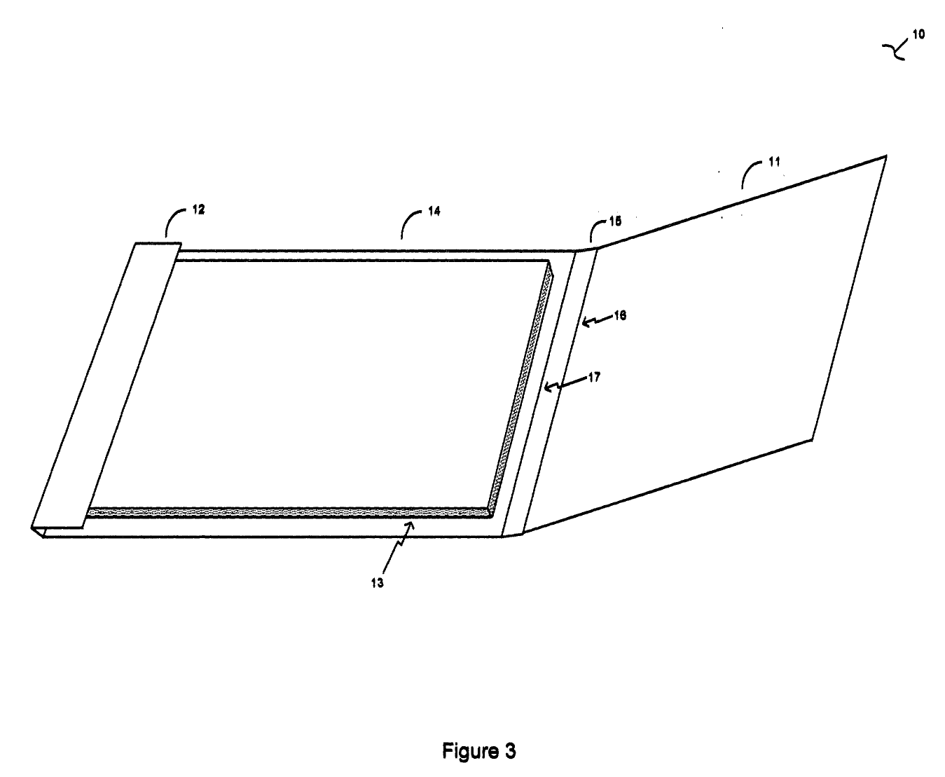

FIG. 3 is a perspective view of the photo album 10 in the open position. The top flap 11 is in the open position to reveal the interior of the mailable photo album 10. In the presently preferred embodiment of the present invention, a plurality of sleeves 13 are securely attached to the photo album 10 such that the top sleeve displays at least one photograph when the photo album is in the open position. The sleeves 13 are formed such that they have one or more pockets to securely hold a photograph.

The top flap 11 securely attaches to the back 14 in such a manner as to allow the top flap to be moved form the open to the closed position. In the presently preferred embodiment the top flap 11 is attached to the back 14 by means of a side attachment flap 15. The side attachment flap 15 is attached to the top flap by an attachment joint 16. Similarly, the side attachment flap is attached to the back 14 by an attachment joint 17. The use of attachment joints allows the top flap to pivot between the open and closed positions.

While the presently preferred embodiment of the present invention uses a side attachment flap to connect the top flap to the back flap, alternate embodiments of the present invention could have the top flap directly attached to the back flap trough an attachment joint.

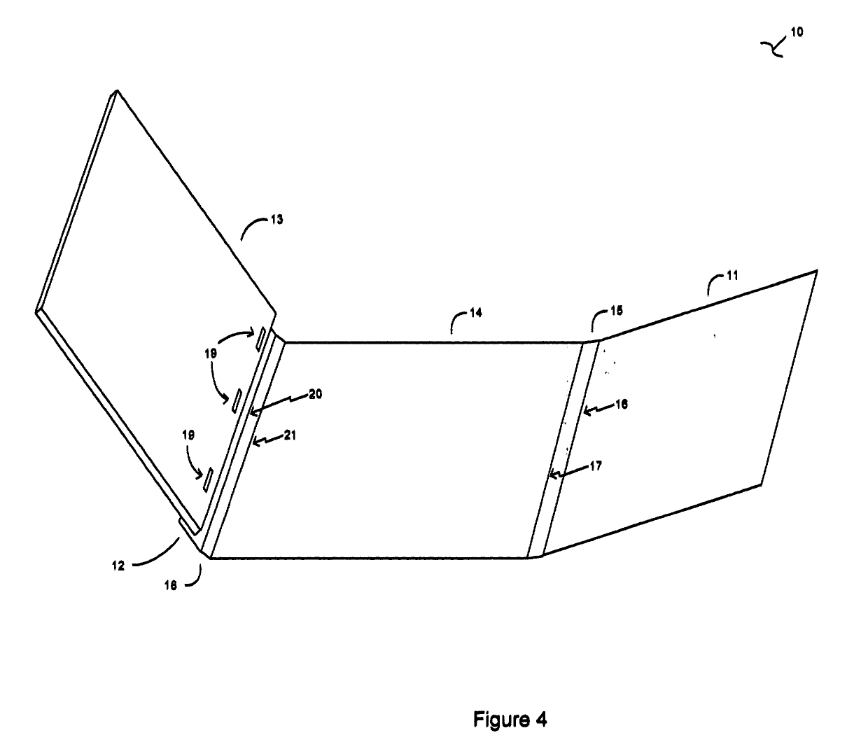

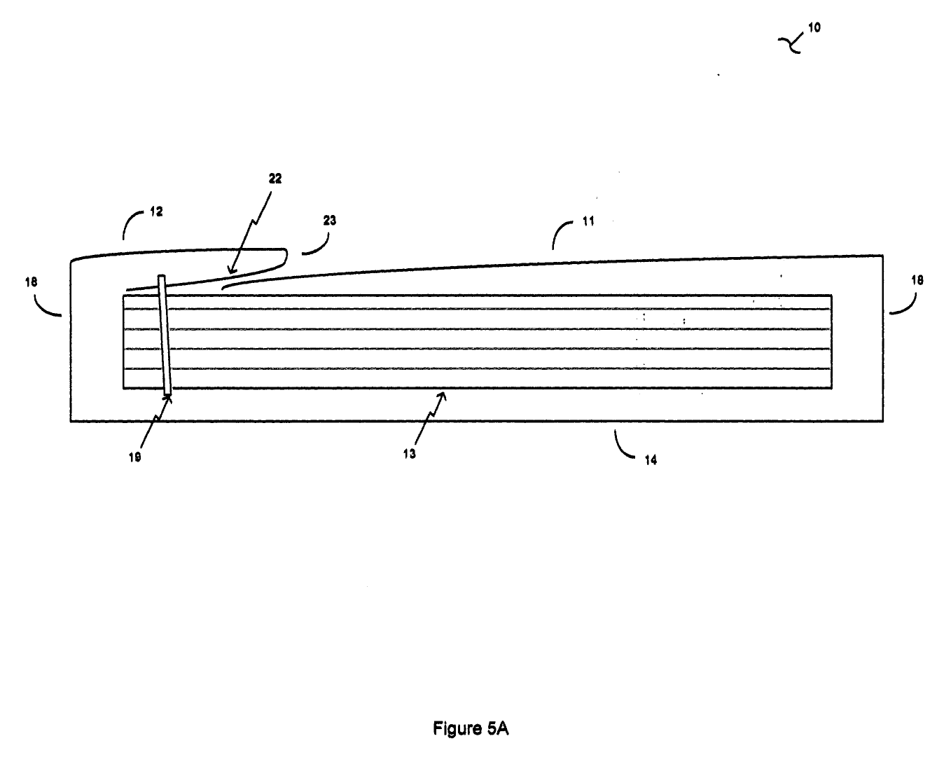

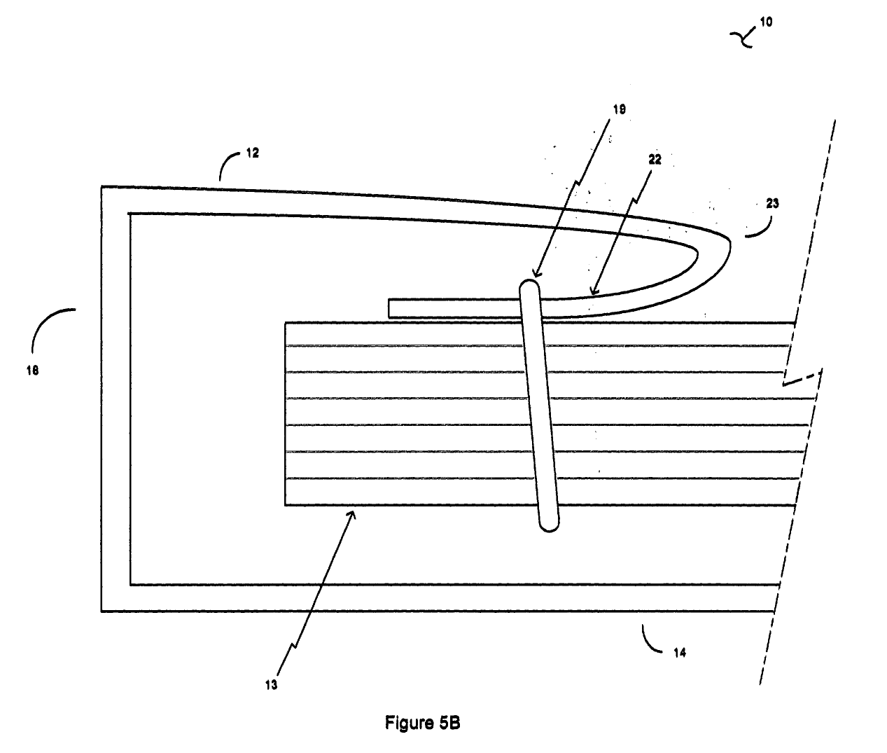

FIG. 4 is a perspective view sleeves 13 rotated to reveal the attachment of the sleeves 13 to the closing flap 12 in the presently preferred embodiment. The sleeves 13 are attached to the cover by a plurality of staples 19, as illustrated in greater detail in FIGS. 5A and 5B below. In the presently preferred embodiment, the closing flap 12 is attached to the back flap 14 by a second side attachment flap 18. The side second side attachment flap 18 is attached to the closing flap 12 by an attachment joint 20. Similarly, the second side attachment flap is attached to the back 14 by an attachment joint 21.

While the presently preferred embodiment of the present invention uses a side attachment flap to connect the closing flap to the back flap, alternate embodiments of the present invention could have the closing flap directly attached to the back flap though an attachment joint, or through the use of multiple side flaps.

In the presently preferred embodiment, the top flap, back flap, closing flap, and side attachment flaps are formed form a single piece of semi-stiff material, folded to form the flaps of a mailable photo album cover. In one embodiment of the present invention, the semi-stiff material used is 360 GSM (grams per square meter) weight paper, folded at the attachment joints 16 and 17 between the top flap and back of the mailable photo album.

While the presently preferred embodiment uses three standard staples, alternate embodiments could use more or fewer staples, or staples of differ sizes.

FIG. 5A is a cross-sectional end view of the mailable photo album illustrating the attachment of the sleeves to the cover. FIG. 5B is an expanded cross sectional view of the attachment of the sleeves to the cover illustrated in FIG. 5A. The top flap 11 is in the closed position second by the closing flap 12. The closing flap is attached to a securing flap 22 by an attachment joint 23. The sleeves 13 are attached to the cover by staples 19 passing through the securing flap 22.

As shown in FIGS. 5A and 5B, the end of the top flap is positioned below the closing flap in the closed position, whereby the closing flap prevents the top flap from inadvertently rotating to the open position. For this embodiment of the present invention, the material chosen for the top flap cover is chosen with the proper stiffness and flexibility to allow the opt flap to remain in the closed position, yet flexible enough for the top flap to be flexed to be removed from the closed position beneath the closing flap.

While the presently preferred embodiment utilizes staples to attach the sleeves to the closing flap, alternate embodiments could use, without limitation, an adhesive, a clip or clips, pins, grommets, or other permanent or temporary fastener.

While the presently preferred embodiment utilizes a securing flap attaching to the closing flap, particularly to prevent the staples used in the preferred embodiment from protruding to the outside surface of the mailable photo album, alternate embodiments could attach the sleeves directly to the closing flap, or to either the back flap or another flap. In such embodiments there may be no need for a separate securing flap, as another flap would also be used to secure the sleeves to the cover of the photo album.

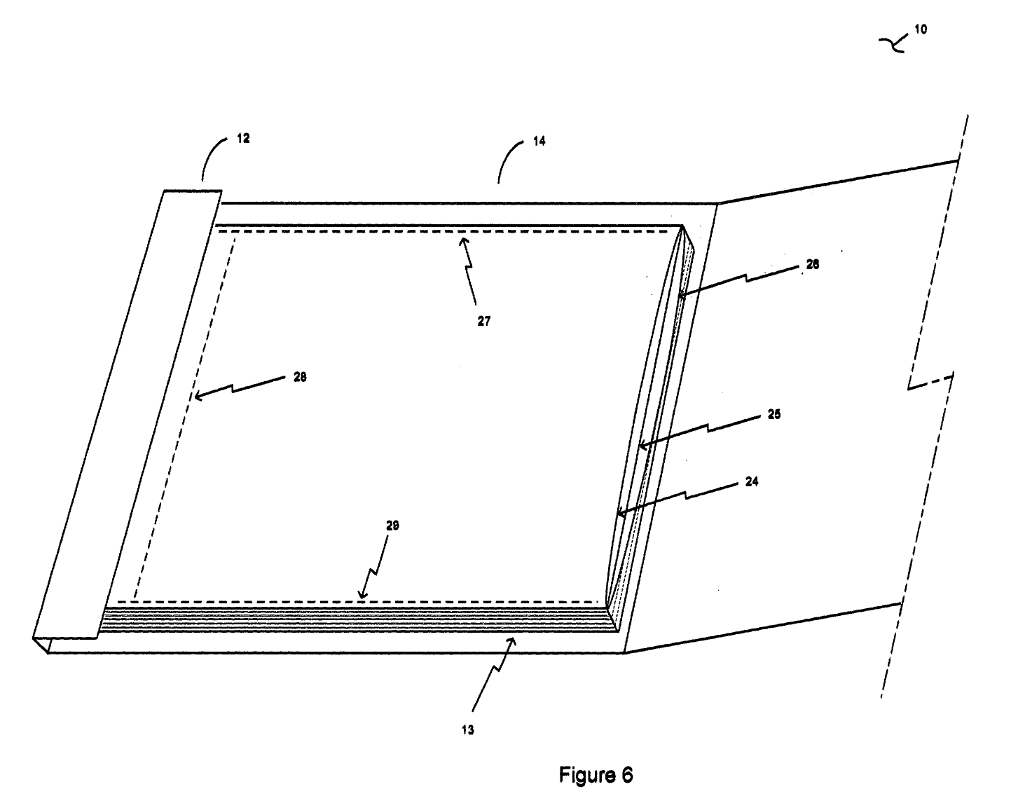

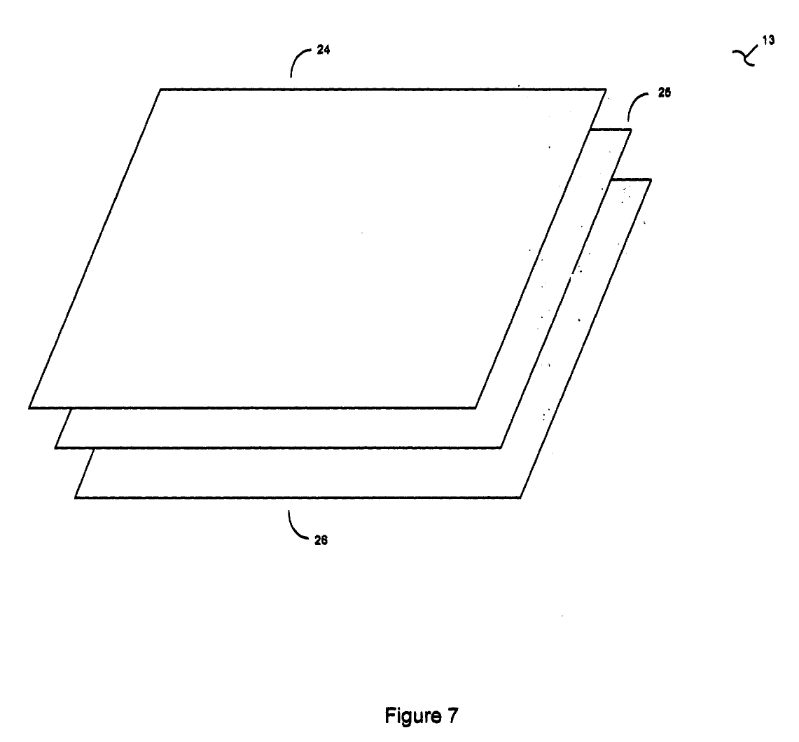

FIG. 6 is a perspective view illustrating the detail of a sleeve 13. In the presently preferred embodiment, the sleeve 13 is formed to have a front pocket and a rear pocket. The front pocket and the rear pocket are formed by sandwiching a top flexible translucent sleeve cover 24 with a flexible opaque sleeve divider 25 and a bottom flexible translucent sleeve cover 26, wherein the sleeve divider is placed between the top flexible translucent sleeve cover and the bottom flexible translucent sleeve cover, as illustrated below in FIG. 7. In the presently preferred embodiment, the pocket openings are located on the side edge of the sleeve, as opposed to the top of the sleeve, to allow the closing of the cover to secure photographs stored within the sleeve pocket. Alternate embodiments of the present invention could have the pocket opening on other sides of the sleeve page.

FIG. 7 is an exploded perspective view of the component sheets of the sleeve 13. As shown, the top flexible translucent sleeve cover 24 and bottom flexible translucent sleeve cover 26 sandwiches the flexible opaque sleeve divider 25. In the presently preferred embodiment, the flexible translucent sleeve covers are formed from clear polypropylene, and the flexible opaque sleeve divider is formed from white polypropylene. In the presently preferred embodiment, 0.17 mm thickness polypropylene sheets are used, due to their light weight yet strength and resilience. In the presently preferred embodiment, the flexible translucent sleeve covers and flexible opaque sleeve divider are heat bonded to form the sleeve and sleeve pocket, thereby securely attaching the flexible translucent sleeve covers and flexible sleeve divider. As shown in FIG. 6, the heat bonding forms an attachment line 27 on the top, on the bottom 28, and along the side 29 closest the attachment to the photo album cover. In the presently preferred embodiment, the boding line 29 serves to give the pocket a defined depth to prevent the edge of a photograph in the pocket from slipping behind the closing cover. The dimensions of the pocket may be chosen to accommodate any size and shape of photograph, for example 4×6 inches or 5×7.

While the presently preferred embodiment utilizes a sleeve divider, alternate embodiments could do without a sleeve divider either by securing forming the sleeve from the sleeve covers or by forming the sleeve from a sleeve cover and a backing material to form an opaque sleeve back.

While the presently preferred embodiment uses heat bonding to form the sleeve from the sleeve covers and sleeve divider, alternate embodiments could use adhesives, stitching or other ways of forming the sleeve and sleeve pocket. In an alternate embodiment, sleeve-pages could be formed from paper pages with photo corners to secure photographs. The photo corners could be formed from slots in the paper, or from an additional piece of paper, whereby a photograph is secured by sliding the edge of the photograph in the slot or underneath the additional paper forming the photo corner. Additionally, the photographs may be secured to sleeve-pages by an adhesive.

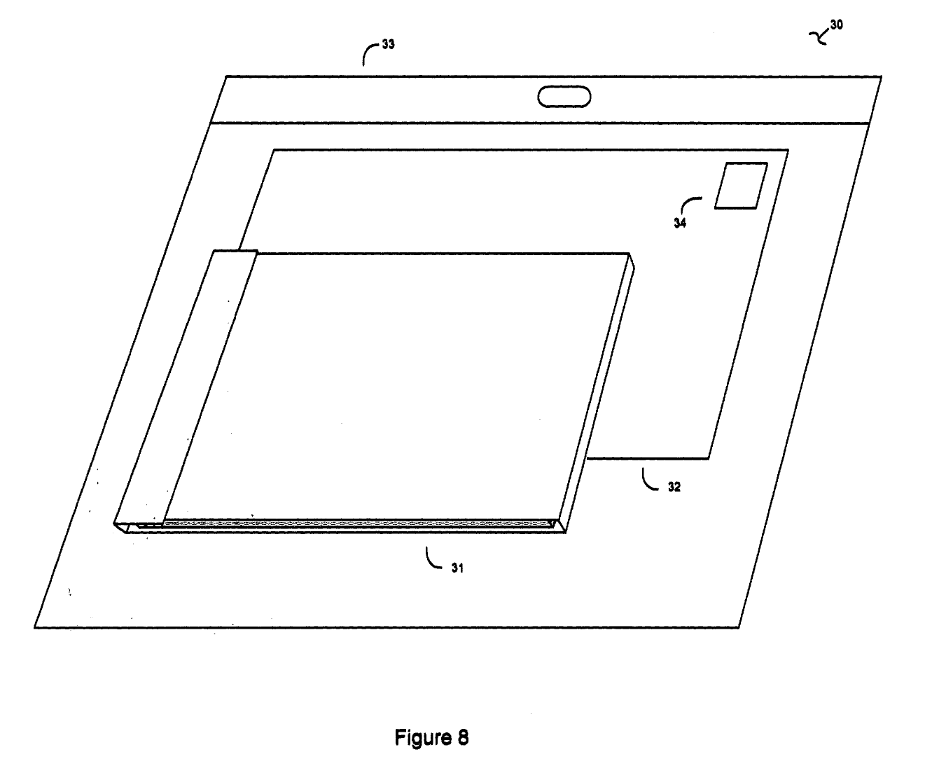

FIG. 8 is a perspective view of a mailer kit 30 including a mailable photo album 31 and a mailing envelope 32 enclosed within a mailer kit display package 33. To facilitate the ease and convenience of sending the mailable photo album through the postal system, the mailing kit includes the photo-album envelope which is sized to hold the mailable photo album with pictures inserted into the sleeves of the mailable photo album. Additionally, the photo-album envelope may include postage sufficient to mail the envelope, for example it may include postage sufficient to mail the photo album with the U.S. via first class mail. Additionally, the mailer kit display package may include a hole for supporting the display package on a holder or rack, as used in retail outlets.

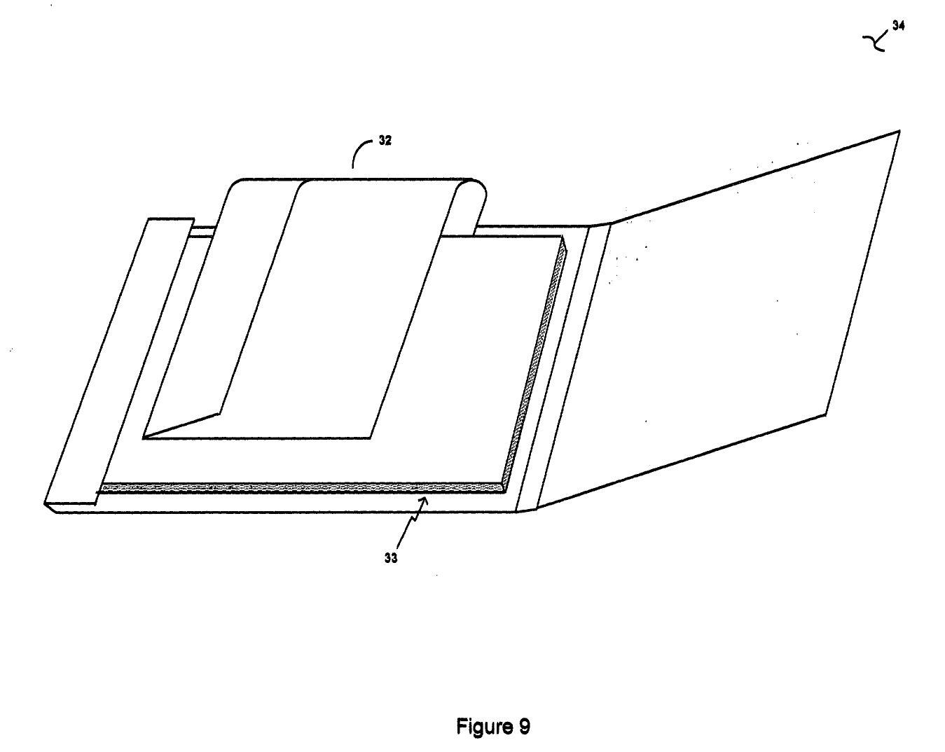

FIG. 9 illustrates the inclusion of a photo-album envelope with the mailable photo album. The photo-album envelope 32 is folded to allow the envelope to fit within the photo album cover. In the presently preferred embodiment, the photo-album envelope is folded over the sleeves 33, to prevent the envelope from inadvertently falling out of the mailable photo album 34.

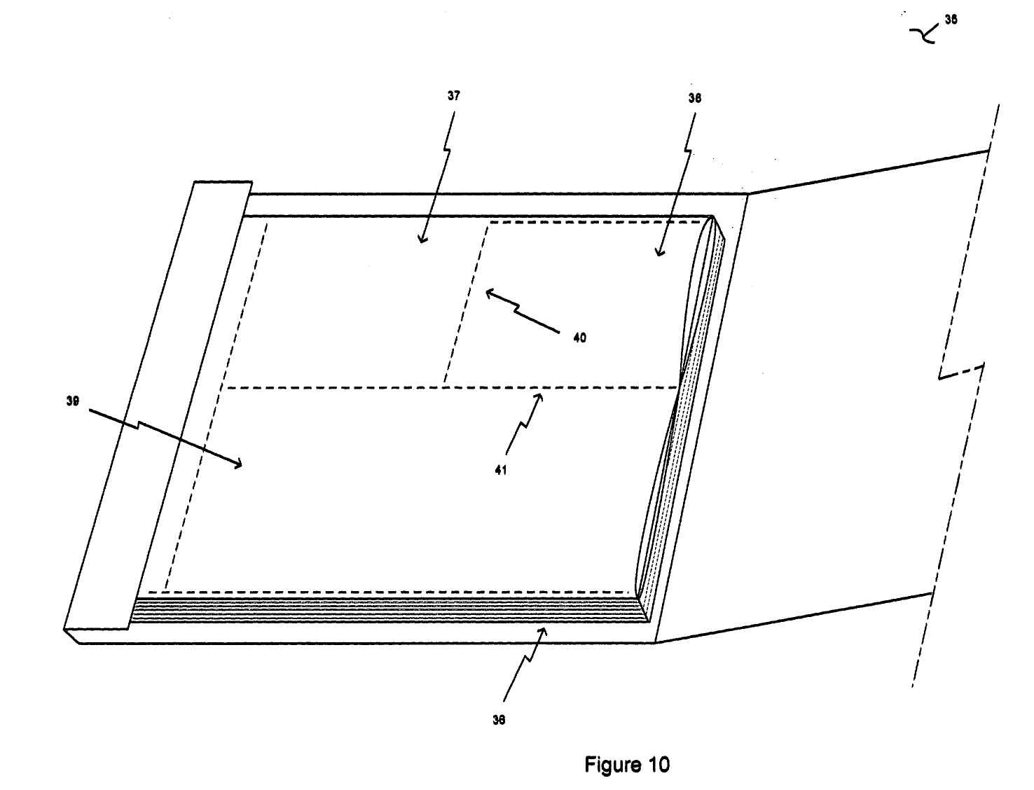

FIG. 10 illustrates an alternate embodiment of the present invention having multiple photo pockets per sleeve. The mailable photo album 35 has a plurality of sleeves 36. The sleeves 36 have three picture holding pockets 37, 38 and 39 of differing sizes. In the presently preferred embodiment, the pockets are formed by heat bonding the flexible translucent sleeve covers and flexible opaque sleeve divider to form pocket dividers 40 and 41 between the photo pockets 37, 38 and 39.

While the example embodiment in FIG. 10 has three photo pockets per sleeve, alternate embodiments could have more or fewer pockets per sleeve. Additionally, alternate embodiments of the present invention could have sleeves with differing numbers of pockets in a single mailable photo album.

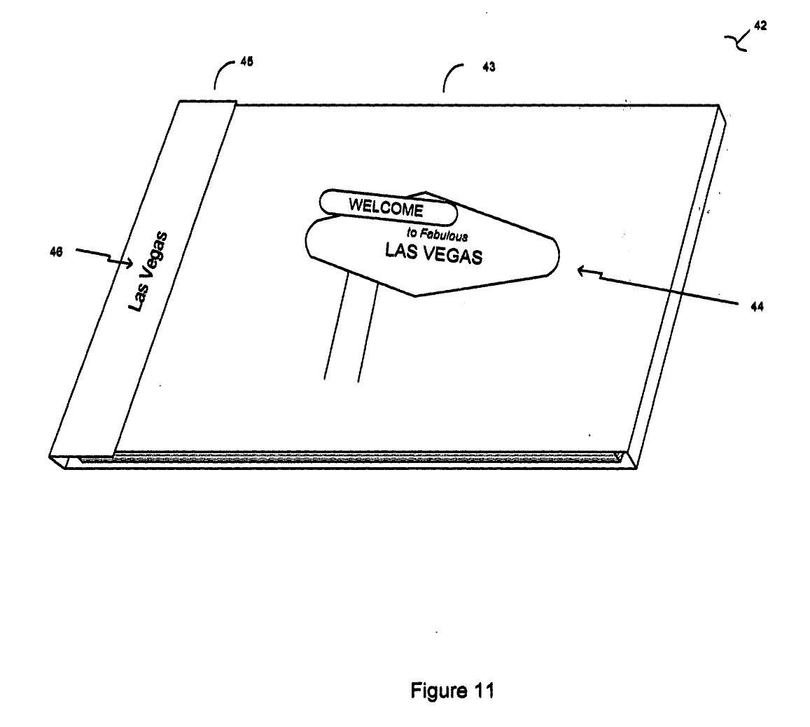

FIG. 11 depicts and alternate embodiment of the present invention where a mailable photo album 42 includes theme identifiers. The top flap 42 includes a theme graphic 44 on the top flap 42. Additionally, in the presently preferred embodiment the closing flap 45 has a theme identifier 46. In the presently preferred embodiment, the theme graphic of the top flap is graphic image representative of a particular theme. The theme illustrated in the graphic image is of a particular vacation destination. Specifically, the particular vacation destination is Las Vegas. Additionally, the theme identifier of the closing flap identifies the particular theme depicted in the theme graphic. In the example embodiment shown in FIG. 11, the theme identifier is the name of the location depicted in the theme graphic.

While the presently preferred embodiment has the theme identifier on the closing flap and the theme graphic on the top flap, alternate embodiments of the present invention could use any combination of theme identifiers and/or theme graphics on any of the flaps of the mailable photo album. In an alternate embodiment of the present invention, the top flap has a window which forms a pocket to frame a photograph out of the top flap. In such an embodiment the pocket formed in the top flap holds a single photograph, which is visible through the top flap window. In this manner the theme graphic or theme identifier (or both) is the personal photograph inserted in the top flap window pocket.

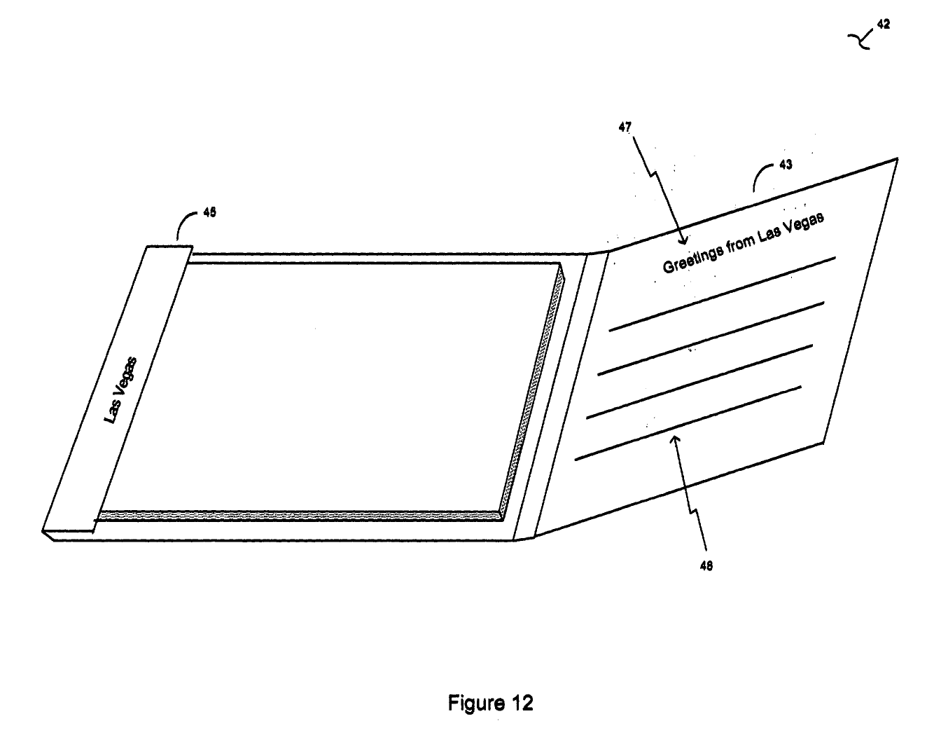

FIG. 12 is a perspective view of the alternate embodiment of the mailable photo album 42 shown FIG. 11 illustrating a theme message 47 and customizable note lines 48 inside the top flap 43. Thus, the theme message and note lines allow the mailable photo album to be used as a greeting card, with the enhancement of sending personalized photographs which may be appropriate to the corresponding theme and message of the photo album.

While the presently preferred embodiment has the theme message and customizable note lines on the inside of the top flap of the mailable photo album, alternate embodiments could have either or both the theme message and customizable note lines on another part of the inside of the photo album, or on any of the flaps of the outside cover of the photo album.

The use of theme identifiers, theme message and theme graphics complements the inclusion of the mailable photo album in a mailing kit. In an alternate embodiment the mailing envelop includes the proper postage to a given location where a given visitor to the vacation destination may be from, allowing the vacationer to conveniently mail set of pictures to friends or relatives back hop in a photo album identifying the vacation destination, with a message and note.

In the example embodiment shown in FIG. 11 the theme is of a vacation to Las Vegas, with graphic image representing the famous “Welcome to Las Vegas” sign. Similarly, the theme identifier is “Greetings from Las Vegas.” The message printed in the mailable photo album shown in FIG. 11 is related to the theme and reads “Just a few photos of our trip to Vegas.”

As one of ordinary skill in the art will appreciate, other identifiers, images or messages, or other combinations of identifiers, images or message could be used for a given theme, or subtle variations could be introduced to give specific meaning to the theme, for example: winning in Las Vegas. Examples of alternate themes include, without limitations, a specific holiday such as Christmas or New Years, an event such as the Super Bowl or a concert, a birthday, announcement of a new baby, a wedding, granddaughter or grandson, a generalized vacation theme or vacation theme relating to a particular activity such as skiing or mode of travel such as mobile home or airplane, astronomical sign, or other image or graphic relating to a theme. Additionally, the theme could involve a corporate logo, which is particularly suitable for promotional events and trade shows.

Additionally, children's themes such as friends, birthday party, a given birthday such as turning five, summer camp, their family or hometown, as well as activities such as little league or girl scouts, or even favorite cartoon characters or other children's interest could also be used.

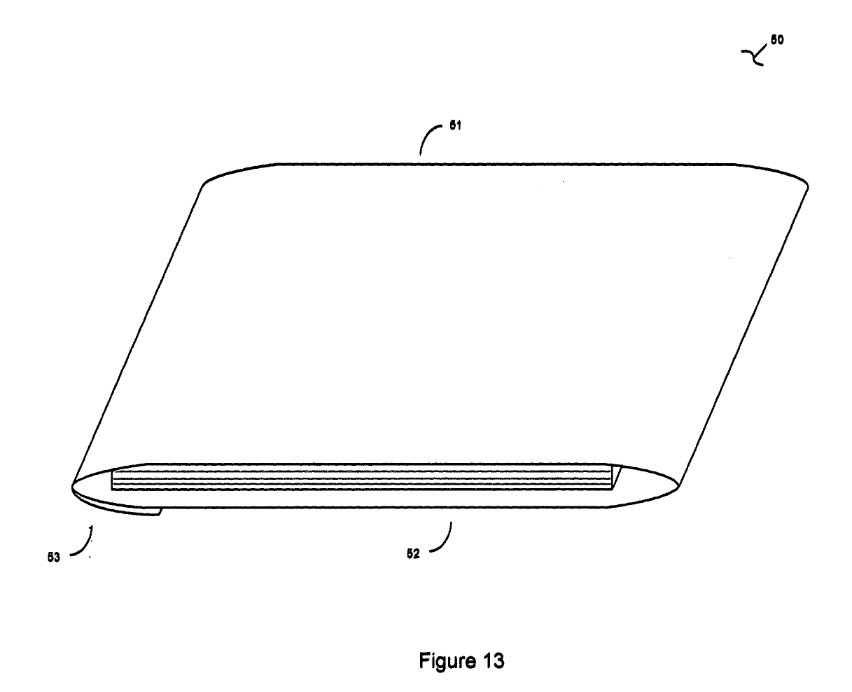

FIG. 13 is a top perspective view of a mailable photo album with an alternate cover and closing system. The mailable photo album 50 has a top flap 51 which in the closed position (depicted) covers the entire top of the photo album.

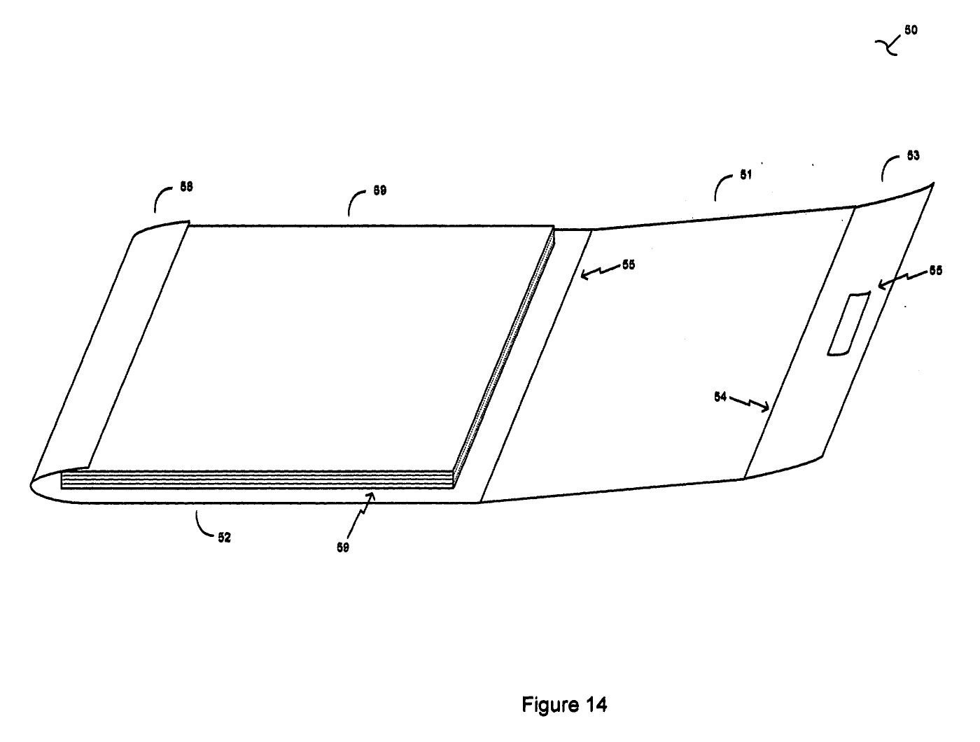

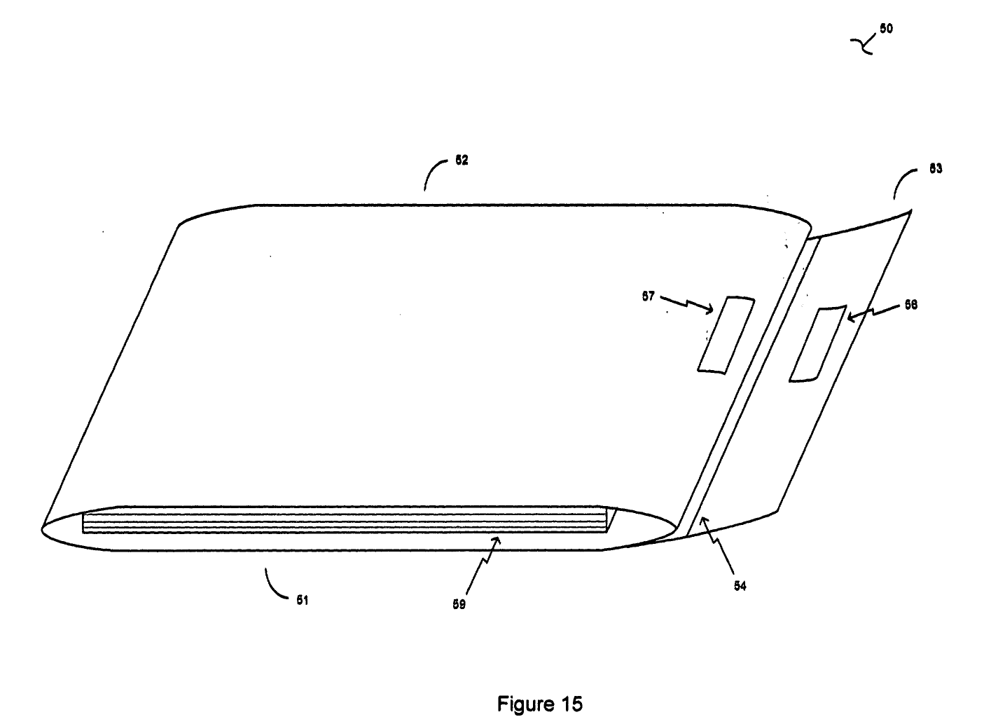

FIG. 14 is a perspective view of the mailable photo album 50 shown in FIG. 13 in the open position. FIG. 15 is a bottom perspective view of the mailable photo album shown in FIGS. 13 and 14 illustrating the hook and loop closing system, in accordance with the present invention. The top flap 51 attaches to a back flap 52 on one end and to a closing flap 53 on the other end. The closing flap and the back flap are attached to the front flap via attachment joints 54 and 55 to allow the opening and closing of the photo album. The closing flap 53 has a securing mechanism to secure the top flap in the closed position. In the presently preferred embodiment, the securing mechanism includes a piece hook and loop fastening material such as a piece of Velcro™ 56, affixed to the inside of the closing flap 53 and a corresponding piece of Velcro 57 affixed to the back flap 52 illustrated in FIG. 15. The corresponding securing piece of Velcro affixed to the back flap is positioned to match with the Velcro of the closing flap such that in the closed position the two pieces of Velcro interlock to securely hold the top flap in the closed position.

The back flap 52 attaches to a securing flap 58, preferably through an attachment joint in a manner similar to attachment joint 55 or to the attachment shown in FIG. 4. The sleeves 59 are attached to the securing flap 58 in a manner similar to that disclosed in connection with FIGS. 5A and 5B.

In the presently preferred embodiment, the alternate back side closing system shown in FIG. 13 through 15 the securing flap, closing flap, back flap and top flap are all formed from a single piece of semi-stiff material, folded to form the attachment joints.

While the embodiment shown in FIGS. 13 through 15 uses a separate closing flap to secure the top in the closed position, alternate embodiments could have the securing mechanism directly attach the top flap in the closed position. For example, one way to securely hold the top flap in the closed position it with the use of Velcro on the underside of the top flap, with a corresponding piece of Velcro attached to the securing flap or to the back flap. Another example of a securing mechanism would be the use of a pin and tie system, where a string or elastic cord attached to a secure mounting point is tied around a pin, the pin being located on the corresponding cover flap to allow the top flap to be held in the closed position.

It will be understood to those skilled in the related arts that while the present invention has been described with respect to displaying and protecting photographs, such an album is useful for displaying and presenting other types of graphics or text, including, without limitation, newspaper clippings, printings, photocopies, printouts, drawings, etc.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

1. A mailable photo album, comprising:
a cover including:
a back flap,
a top flap attached to the back flap in a rotatable manner, and
a closing flap attached to the back flap, the closing flap formed to secure the top flap by extending over one edge of the top flap in the closed position:
a plurality of sleeves securely attached to said cover, the sleeves including:
at least one pocket designed to securely hold a photograph such that the photograph is viewable when securely held within the sleeve pocket.

2. The mailable photo album of claim 1, wherein the cover is formed from a single piece of semi-stiff material.

3. The mailable photo album of claim 2, wherein a heavy weight paper is used as the cover material.

4. The mailable photo album of claim 2, wherein the sleeves are formed from thee pieces of flexible material sandwiched and attached to form at least two pockets, one pocket on either side of the sleeve.

5. The mailable photo album of claim 3, wherein the three pieces of flexible material are formed from sheets of polypropylene, and wherein at least two of the sheets are translucent to allow viewing of a photograph held within the sleeve pocket.

6. The mailable photo album of claim 4, wherein the three pieces of polypropylene are attached heat bonding for form a sleeve and pocket.

7. The mailable photo album of claim 5, wherein the sleeve has at least two pockets on one side, said multiple pockets separated by dividers formed by heat bonding.

8. A photo album suitable for mailing, comprising:
a cover formed from a single piece of lightweight semi-stiff material, the cover folded to form a top flap, a back flap, and a securing flap; and
at least one sleeve page securely attached to the securing flap of the cover, the sleeve page including at least one pocket for holding a photograph, wherein the sleeve page is formed from layers of lightweight flexible material, at least one of the layers being translucent to allow viewing of a photograph contained in the sleeve pocket.

9. The photo album of claim 8, wherein the attachment of the at least one sleeve page is by a plurality standard size staples, the standard size staples passing through the at least one sleeve page to the securing flap.

10. The photo album of claim 9, wherein the cover formed from a single piece of lightweight semi-stiff material further includes a closing flap, the closing flap formed to secure the top flap in the closed position.

11. The photo album of claim 10, wherein the closing flap attaches to the back flap, and wherein the closing flap secures the top flap in the closed position by extending over a portion of the top cover to prevent the top cover from inadvertently rotating to the open position.

12. The photo album of claim 10, wherein the closing flap includes a securing mechanism, the securing mechanism formed to secure the top flap in the closed position,

13. The photo album of claim 12, wherein the mechanism is a hook and loop fastening system.

14. The photo album of claim 12, wherein the securing flap securely attaches to the closing flap, the closing flap securely attaching the securing flap to the back flap.

15. The photo album of claim 10, wherein the closing flap attaches to the back flap by an attachment flap, the back flap securely attaching to the attachment flap, and the closing flap securely attaching to back flap.

16. The photo album of claim 11, wherein the closing flap securely holds the top flap in the closed position by extending over one edge of the top flap in the closed position.

17. The photo album of claim 8, wherein the closing flap attaches to the top flap, the top flap rotatably attaching to the back flap, and wherein the securing flap attaches to the back flap, the closing flap securely holding the top flap in the closed position.

18. The photo album of claim 17, wherein the closing flap includes a securing mechanism, the securing mechanism formed to secure the top flap in the closed position.

19. The photo album of claim 18, wherein the securing mechanism is a hook and loop fastening system.

20. The mailable photo album of claim 8, wherein the cover includes a theme graphic.

21. The mailable photo album of claim 20, wherein the cover further includes a theme identifier.

22. The mailable photo album of claim 21, wherein the mailable photo album further includes a theme message.

23. The mailable photo album of claim 22, wherein the mailable photo album further includes a plurality of customizable note lines.

24. A mailable photo album, comprising:
a cover formed from a lightweight semi-stiff material;
a securing mechanism for keeping the cover in a closed position; and
a plurality of sleeves securely attached to the cover, where in the sleeve is formed to hold at least one photograph, and wherein the sleeves are formed from a lightweight flexible material.

25. The mailable photo album of claim 24, wherein the cover is formed from a single piece of the lightweight semi-stiff material.

26. The mailable photo album of claim 25, wherein the lightweight semi-stiff material is folded to form:
a top flap,
a back flap, and
a securing flap, wherein the sleeves are attached to the securing flap

27. The mailable photo album of claim 26, wherein the cover also includes a closing flap, the closing flap formed to secure the top flap in the closed position.

28. The mailable photo album of claim 27, wherein the closing flap is attached to the top flap, and wherein the securing mechanism is attached to the closing flap.

29. The mailable photo album of claim 28, wherein the securing mechanism attached to the closing flap is a piece of hook and loop material, and wherein a corresponding piece of hook and loop closing material is affixed to the cover in a manner to allow the top flap to be securely held in the closing position by the interlocking of the corresponding hook and loop securing pieces.

30. The mailable photo album of claim 24, wherein the cover includes a theme graphic.

31. The mailable photo album of claim 24, wherein the cover further includes a theme identifier.

32. The mailable photo album of claim 31, wherein the mailable photo album further includes a theme message.

33. The mailable photo album of claim 32, wherein the mailable photo album further includes a plurality of customizable note lines.
